(19) United States
(12) Patent Application Publication
(10) Pub. No.: US 2006/0114245 A1
(43) Pub. Date: Jun. 1, 2006

(54) Touch screen cover

(76) Inventors: Timothy E. Masters, Georgetown, TX (US); Vincent M. Vancho, Dove Canyon, CA (US)

Correspondence Address: TYCO ELECTRONICS CORPORATION, MAIL STOP R20/2B, 307 CONSTITUTION DRIVE, MENLO PARK, CA, 94025, US

(21) Appl. No.: 11/002,585

(22) Filed: Dec. 1, 2004

(51) Int. Cl. G09G 5/00

(52) U.S. Cl. 345/175

(57) ABSTRACT

A touch screen cover is provided that includes a display filter having a front surface configured to be positioned to at least partially cover a display screen. The display filter has a rim integrally formed with and extending along at least a portion of a perimeter of the front surface of the display filter. The rim projects outward from the front surface away from the display screen. The rim is configured to pass infrared light therethrough along the front surface. The resulting touch screen cover can be watertight and provide a cleanable surface.

### BACKGROUND OF THE INVENTION

1. Field of the Invention

The present invention relates generally to touch screen sensors, and more particularly, to a monolithically formed infrared touch screen sensor used with an adjoining cover and display filter to form a sealed and cleanable touchscreen system.

2. Introduction to the Invention

Today, a wide variety of conventional touch screen systems are used in various applications. Examples of applications include retail sales, restaurants, point of sale terminals, kiosks, ATM machines, medical systems, e-mail packages and the like. Touch screen systems typically include a display joined with a touch or proximity sensor mechanism. The sensor mechanism detects a user's finger or hand, or an instrument when located proximate the display. The display is controlled to present application-specific information to the user including, among other things, graphics, text, video and audio. The sensor mechanism detects the presence of a finger or instrument and generates a touch screen event in response thereto. The touch screen event includes data or signals representative of the event type and identifying the position (or positions) at which the event occurred.

The display is controlled by the application running on a system computer. The application controls the display to present the application-specific information to the user. The display and touch screen function as a user interface, through which the user inputs data to the application. The user-entered data may represent product information, patient/customer information, medical information, patient vitals, test results, internet addresses, web-site content, e-mail-related content and the like.

Touch screen sensors are built using a variety of technologies such as electronic sensors having resistive networks that sense touch locations based on voltage or current draw, acoustic wavefront coupling based on wave attenuation principles, and light beam technologies that rely on the interruption of cross beams of light.

However, in conventional touch screen systems, the touch sensor is configured to be coupled to the display by mechanical means. In the case of resistive and acoustic touch sensors, the coupling is direct from the sensor to the display by means of an intervening gasket or seal. For infrared touch sensors the coupling mechanisms may includes a touch screen lens cover coupled to a display filter positioned in front of the display, and also coupled to a bezel configured to be attached to the outer perimeter of the display. In at least some known infrared touch screens, a gasket or a seal is positioned between the display filter, and the lens, and the bezel. During use, touch screens accumulate dirt particles, oils, bacteria, and the like, at the interfaces between the components. Typically, even after cleaning the touch screen, a portion of the dirt and bacteria remains in the crevices at the interfaces. In medical applications, remaining dirt and bacteria can be particularly troubling. Additionally, a gap may form between the bezel and the lens, and moisture may pass through the gap and seep behind the touch screen. Moisture seepage may create problems in operation and reliability.

At least some known systems include a film that extends over the touch screen cover. The film may be discarded after use to reduce the dirt and bacteria that collects on the touch screen. However, the films can be expensive to replace and difficult to install.

A need exists for a touch screen system that affords a watertight cover and provides a cleanable surface from which substantially all of the bacteria and dirt may be removed from the surface.

### BRIEF SUMMARY OF THE INVENTION

A touch screen cover is provided including a display filter having a planar front surface configured to be positioned to cover a display screen. The display filter includes a rim integrally formed with and extending along at least a portion of a perimeter of the front surface of the display filter. The rim projects outward from the front surface away from the display screen, and the rim is configured to pass infrared light therethrough along a plane parallel and adjacent to the front surface. Optionally, the rim may entirely surround the perimeter of the front surface of the display filter.

In accordance with at least one embodiment, the touch screen cover includes a bezel integrally formed with the rim. The bezel surrounds the display filter and is positioned forward of the front surface. Optionally, the bezel, the rim and the display filter are monolithically formed as a unitary and integral structure. Additionally, the touch screen cover may include a printed wire board surrounding the rim. The printed wire board includes infrared elements configured to transmit and/or receive infrared traces along a plane parallel and adjacent to the front surface. Optionally, the printed wire board may be snappably mounted to the bezel.

In accordance with at least one embodiment, the rim may be integrally formed with the front surface of the display filter at a transition area having a predetermined radius of curvature therebetween. Optionally, the rim may form an infrared lens having inner and outer surfaces angled at a non-orthogonal angle to infrared traces projecting through the infrared lens.

In accordance with at least one embodiment, the touch screen cover may include an outer bezel integrally formed with the rim, and an inner bezel positioned adjacent the outer bezel. Optionally, a printed wire board may be snappably mounted to the inner bezel such that the inner bezel is positioned between the printed wire board and the outer bezel.

### BRIEF DESCRIPTION OF THE DRAWINGS

FIG. 1 illustrates a block diagram of a touch screen system formed in accordance with an embodiment of the present invention.

FIG. 2 illustrates an exploded perspective view of a touch screen cover formed in accordance with an embodiment of the present invention.

FIG. 3 illustrates a cross-sectional side view of the touch screen cover shown in FIG. 2 when assembled and mounted onto a display.

FIG. 4 illustrates an enlarged side view of a portion of the touch screen cover shown in FIG. 3.

### DETAILED DESCRIPTION OF THE INVENTION

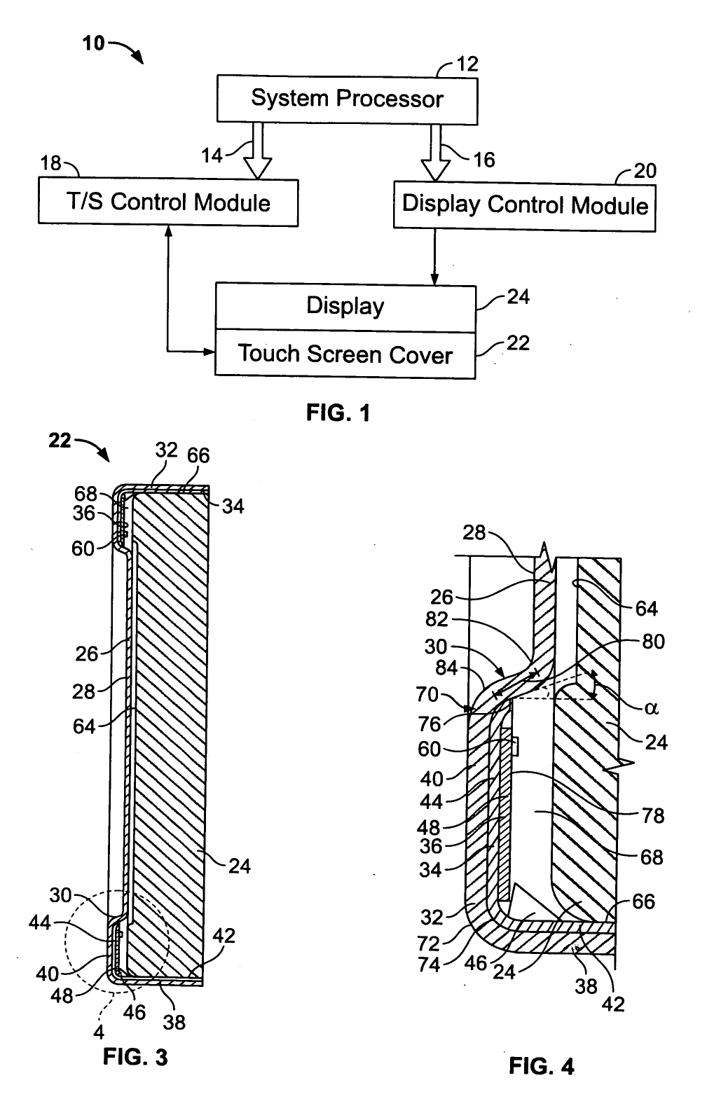

FIG. 1 illustrates a touch screen system 10 formed in accordance with an embodiment of the present invention. The touch screen system 10 includes a system processor 12 which performs overall control of the touch screen system 10, including implementation of applications for various industries. The system processor 12 communicates over a bus or bi-directional links 14 and 16 with a touch screen control module 18 and a display control module 20, respectively. The touch screen control module 18 transmits control signals to and receives sensor signals from a touch screen cover 22.

By way of example, the control signals transmitted from the touch screen control module 18 may include timing signals, ultrasound drive transmissions, optical drive signals and the like. The sensor signals supplied from the touch screen cover 22 represent touch events. A touch event occurs when a user's hand or finger or an instrument contacts a touch sensitive pad or is placed in sufficiently close proximity to the touch screen overlay to be detected by the sensing mechanism. The sensor signals also include coordinate information indicative of the position at which the touch event. The information may constitute a pixel location, a row and column combination, an X and Y coordinate combination within the coordinate system of the touch screen cover 22 and the like.

The display control module 20 controls presentation of graphical information on the display 24. The graphical information may represent one or more windows or screens having associated therewith one or more active areas. The display 24 may represent, among other things, a personal digital assistant, a point of sale terminal, an automated teller machine, a user interface of a medical system, and the like. The system processor 12 coordinates operation between the touch screen control module 18 and the display control module 20 such that the graphical areas presented on the display 24 are defined as active areas by the system processor 12 by correlating the active area with one or more functions.

FIG. 2 illustrates an exploded perspective view of the touch screen cover 22 formed in accordance with an embodiment of the present invention. In the illustrative embodiment shown in FIG. 2, the cover 22 is rectangularly shaped such that the touch screen cover 22 may be positioned around the display 24 (as depicted in FIG. 1), such as, for example, a computer monitor, a piece of medical equipment, a piece of industrial equipment, and the like. Although, in the illustrative embodiment, touch screen cover 22 is illustrated as having a rectangular shape, the touch screen cover 22 may have any shape desired, depending on the particular application or type of display 24 for which touch screen cover 22 is being utilized. For example, touch screen cover 22 may have a circular shape, a triangular shape, or a non-traditional shape without departing from the scope of the apparatus described herein.

The touch screen cover 22 includes a display filter 26 having a planar front surface 28 configured to be positioned to cover the display 24 (depicted in FIG. 1). The display filter 26 provides a rigid surface that is touched when the touch screen system 10 is in use. A rim 30 is integrally formed with and extends along an entire perimeter of the front surface 28 of the display filter 26. The rim 30 projects outward from the front surface 28 away from the display 24 in the direction of arrow A. The rim 30 passes infrared light therethrough along the front surface 28, as will be described in more detail below.

The touch screen cover 22 also includes an outer bezel 32 integrally formed with the rim 30. The outer bezel 32 surrounds the display filter 26 and is positioned forward of the front surface 28 and the rim 30, an inner bezel 34, and a printed wire board 36, as described in detail below. The outer bezel 32 includes side walls 38 defining an outer perimeter of the touch screen cover 22. Additionally, the outer bezel 32 includes front walls 40 extending radially inward from the side walls 38, and defining a front or outer surface of the touch screen cover 22. Optionally, the front walls 40 may extend perpendicularly from the side wall 38 along a plane parallel to a plane of a front face of the display 24. The side walls 38 are oriented to face each other and wrap around the front walls 40 to form a display receiving pocket 41 therebetween. The pocket 41 has an open back end oriented to receive the display 24 (depicted in FIG. 1) and an opposed front end. The front end of the pocket 41 is defined by the front walls 40, the rim 30, and the display filter 26.

In one embodiment, the outer bezel 32 is a single unitary piece. As such, the side walls 38 and the front walls 40 are continuously formed. The outer bezel 32 may be fabricated from a material such as, for example, a polymer (plastic) material such as a polycarbonate material, a polystyrene material, a polyethylene material, or an acrylic material; a glass material; or the like. The outer bezel 32 may be fabricated from a manufacturing process, such as, for example, a molding process or a machining process. Optionally, the outer bezel 32 may be fabricated from multiple materials and co-molded into a single member. As such, a portion of the outer bezel 32 may have a first set of characteristics, such as, by way of example only, being transparent and rigid, while another portion of the outer bezel 32 may have a different set of characteristics, such as, for example, being opaque and elastic.

The inner bezel 34 includes side walls 42 and front walls 44 that are oriented in a substantially similar manner as the side walls 38 and the front walls 40 of the outer bezel 32. The front walls 44 of the inner bezel 34 extend radially inward from the side walls 42. In FIG. 2, the inner bezel 34 does not include a rim or a display filter. Alternatively, the inner bezel 34 may include a rim (not shown) and/or a display filter (not shown). The inner bezel 34 is dimensioned to have an outer envelope that fits within the outer bezel 32 when the touch screen cover 22 is assembled. Optionally, the inner bezel 34 may snappably engage the outer bezel 32 when assembled. Alternatively, a gap (not shown) may extend between at least a portion of the inner bezel 34 and the outer bezel 32 when the touch screen cover 22 is assembled. In an alternative embodiment, the inner bezel 34 is a film laminated to the outer bezel 32.

In one embodiment, a plurality of retention members 46 extend from the inner bezel 34 for retaining the printed wire board 36 when the touch screen cover 22 is assembled. Optionally, the retention members 46 may be moveable between a neutral position and an extended position to allow the printed wire board 36 to be installed. In the neutral position, the retention members 46 are configured to retain the printed wire board 36 in a stationary position.

The printed wire board 36 includes a frame assembly 48 configured to be positioned along the front wall 44 of the inner bezel 34. Optionally, the printed wire board 36 may also be positioned adjacent the rim 30 of the outer bezel 32. Alternatively, the printed wire board 36 may be positioned along the outer bezel 32. The frame assembly 48 includes a first frame member 50, an opposite second frame member 52, a third frame member 54, and an opposite fourth frame member 56. The first and second frame members 50 and 52, respectively, are oriented generally orthogonally with respect to the third and fourth frame members 54 and 56, respectively. The frame members 50, 52, 54 and 56 define an opening 62 through an inner portion of the frame assembly 48 to allow a user to view the display 24 (depicted in FIG. 1) when the touch screen cover 22 is assembled. Additionally, each of the frame members 50, 52, 54 and 56 includes opto-electronic elements 60 configured to send and/or receive infrared signals. In one embodiment, opto-electronic elements 60 are infrared-light emitting diodes (LEDs) and photo transistors used for touch-sensing in the touch screen system 10.

FIG. 3 illustrates a cross-sectional side view of the touch screen cover 22 when assembled and mounted to the display 24. The touch screen cover 22 is mounted on the display 24 such that the display filter 26 is positioned adjacent a display screen 64 of the display 24. Specifically, the planar front surface 28 of the display filter 26 is positioned to cover the display screen 64. As such, a user can view the display screen 64 through the front surface 28 of the display filter 26. In one embodiment, the touch screen cover 22 is snappably coupled to the display 24. Specifically, the inner bezel 34 and/or the outer bezel 32 contact an outer surface 66 of the display 24 and the touch screen cover 22 is frictionally retained thereon. Alternatively, the touch screen cover 22 may be coupled to the display 24 by a known fastener, such as, by way of example only, a screw, an adhesive, or the like.

As illustrated in FIG. 3, the side walls 42 and/or 38 of the inner bezel 34 and/or the outer bezel 32, respectively, contact the outer surface 66 of the display 24. The corresponding front walls 44 and 40 are positioned radially inward from the forward end of the side walls 42 and 38. In FIG. 3, the front walls 44 and 40 are oriented generally perpendicular with respect to the side walls 42 and 38. In one embodiment, a radius of curvature is formed at the transition between the side walls 42 and 38 and the respective front walls 44 and 40.

The display filter 26 is recessed with respect to the front wall 40 of the outer bezel 32. Specifically, the rim 30 extends between the front wall 40 and the display filter 26 along the perimeter of the display filter 26 and causes the display filter 26 to be recessed. Additionally, because the front wall 40 of the outer bezel 32 is positioned forward of the front surface 28 of the display filter 26, a gap 68 is formed between the front wall 40 and the display 24, and the printed wire board 36 is positioned within the gap 68. Moreover, the printed wire board 36, specifically the opto-electronic elements 60 coupled to the printed wire board 36, is positioned along the rim 30. As such, the opto-electronics elements 60 pass light, such as infrared light, through the rim from one side to the other side of the touch screen cover 22 along the front surface 28 of the display filter 26.

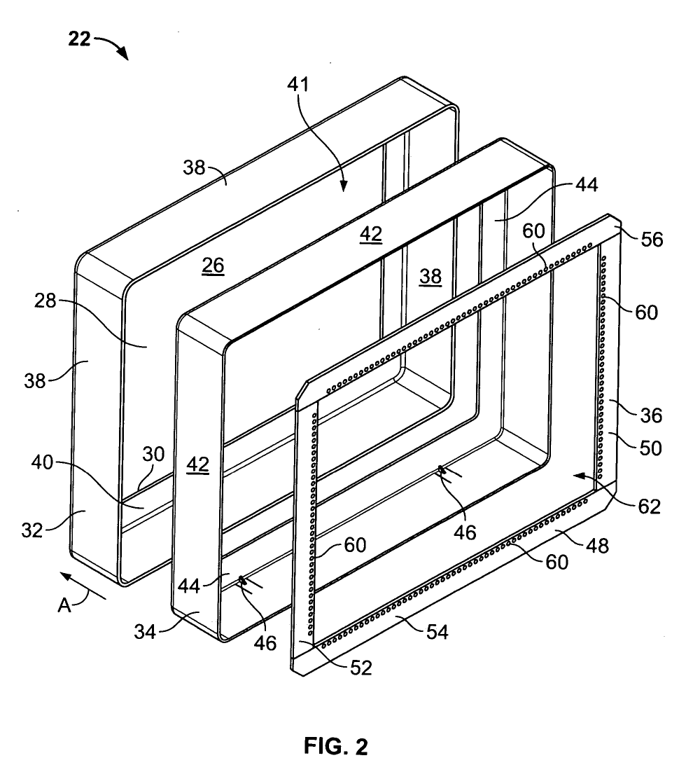

FIG. 4 illustrates an enlarged side view of a portion (area 4) of the touch screen cover 22 shown in FIG. 3. As illustrated in FIG. 4, the display filter 26, the rim 30, and the outer bezel 32 are monolithically formed into a single outer member 70 that includes an outer surface 72 and an inner surface 74. The outer surface 72 is exposed to the ambient environment and is susceptible to collecting dirt, moisture, bacteria, and the like. As such, the outer surface 72 may be cleaned by a user prior to use of the touch screen system 10.

In one embodiment, the outer member 70 may be transparent. To shade and/or hide the internal components of the touch screen cover 22, such as, for example, the frame assembly 48 and the elements 60, the inner bezel 34 may be opaque. Specifically, the inner bezel 34 is dyed or injected with a coloring material and is positioned along a portion of the inner surface 74 of member 70. In one embodiment, the inner bezel 34 is positioned adjacent the front wall 40 and the side wall 38 of the outer bezel 32 to shade the frame assembly 48 from being viewed from the front of the touch screen cover 22. Optionally, the inner bezel 34 may have a design feature, such as, for example, a company name or logotype, placed thereon such that the design feature is visible through the transparent outer bezel 32. Optionally, the inner bezel 34 may include a lip 76 that extends at least partially along the inner surface 74 of the member 70 at the rim 30. The lip 76 may cover a portion of the printed wire board 36 adjacent the rim 30 from being viewed from the front of the touch screen cover 22, but does not cover the opto-electronic elements 60. In alternative embodiments, the touch screen cover 22 does not include the inner bezel 34. In such embodiments, to shade and/or hide the internal components of the touch screen cover 22, a portion of the outer bezel 32, such as, for example, the front wall 40 and/or the side wall 38, may be opaque, while other portions of the outer bezel 32, the rim 30, and/or the display filter 26 may be transparent.

The printed wire board 36 is positioned adjacent the inner bezel 34 and is retained by the retention members 46 extending from the inner bezel 34. Alternatively, the printed wire board 36 may be secured to the inner bezel 34 by a fastener, such as, but not limited to, a screw or adhesive. When assembled, the opto-electronic elements 60 are positioned on an inner surface 78 of the printed wire board 36 and are oriented to direct a trace, such as, for example, an infrared trace, towards the rim 30. In one embodiment, the rim 30 defines a transparent lens that is transparent optically to the infrared trace, and as such, the light is able to pass through the rim 30. Specifically, the trace passes through the rim 30 and is transmitted along the planar front surface 28 of the display filter 26.

The trace is transmitted a distance from the front surface 28 of the display filter 26 such that a user contacts the trace prior to contacting the front surface 28 of the display filter 26. For example, the trace may be transmitted along a line located approximately one to three millimeters from the front surface 28 of the display filter 26. Alternatively, the trace may be transmitted along a line located approximately three to ten millimeters from the front surface 28 of the display filter 26. Optionally, the trace may be transmitted along a line located at approximately twenty-five millimeters from the front surface 28 of the display filter 26. The transmission distance of the trace is variably selected based on the particular application of the touch screen system 10, and depends, at least in part, on the signal reliability and the need to minimize parallax caused by the distance between the display screen 64 and the plane at which the infrared signals are transmitted.

In one embodiment, the touch screen system 10 can function as a “no touch” system to reduce the amount of dirt, bacteria, and moisture contacting the display filter 26. For example, in one embodiment, the touch screen system 10 may be utilized in a medical application, such as, for example, a surgical procedure in which a doctor may be using the touch screen system 10. To reduce the risk of touching the display filter 26 with a finger or a device, and possibly contaminating the patient with bacteria that may be contained on the touch screen cover 22, the traces are transmitted a substantial distance, such as, for example, between approximately twenty and thirty millimeters from the surface 28 of the display filter 26. Additionally, by reducing the risk of touching the touch screen cover 22, the risk of soiling and/or contaminating the touch screen cover 22 with bacteria and the risk of leaving an amount of residue on the display filter 26 is reduced.

Moreover, a width 80 of the rim 30 is variably selected to define the transmission distance of the trace desired for the particular application. Specifically, because the front wall 40 of the outer bezel 32 is integrally formed with the rim 30, because the inner bezel 34 is positioned adjacent the outer bezel 32, and because the printed wire board 36 is positioned adjacent the inner bezel 34, the rim width 80 determines the transmission distance of the trace with respect to the front surface 28 of the display filter 26. Moreover, the amount of recess of the display filter 26 with respect to the front wall 40 of the outer bezel 32 is directly proportional to the rim width 80.

The outer member 70 includes the rim 30 which is positioned between, and integrally formed with, the front wall 40 of the outer bezel 32 and the display filter 26. In one embodiment, the rim 30 is non-orthogonally oriented with respect to each of the front wall 40 and the display filter 26. Additionally, the rim 30 is non-orthogonally oriented with respect to the traces extending through the rim 30 when the touch screen system 10 is in use. In one embodiment, the rim 30 extends at an angle α of approximately twenty degrees from orthogonal with respect to the trace. Alternatively, the rim 30 may be more or less than twenty degrees from orthogonal with respect to the trace. In one alternative embodiment, the rim 30 may be substantially perpendicular to the light trace. The preferred orientation is one that allows light to pass from an emitting opto electronic element to a receiving opto-electronic element.

The outer member 70 includes a radiused surface 82 that transitions between the display filter 26 and the rim 30. The outer member 70 also includes a radiused surface 84 between the front wall 40 and the rim 30. Due to the sloped radius of the radiused surface 82 between the rim 30 and the display filter 26, the outer member 70 is devoid of a seam, or a seal, between the rim 30 and the display filter 26. As such, dirt, bacteria, and/or moisture cannot seep into an interface between the rim 30 and the display filter 26. Accordingly, the rounded internal corner defined by the radiused surface 82 provides a readily cleanable surface to facilitate cleaning and/or disinfecting of the outer surface 72 of the outer member 70. Moreover, because the outer member 70 is a monolithic member, the touch screen cover 22 provides a watertight cover to protect the display 24.

Additionally, because the outer member 70 is snappably coupled to the display 24, the outer member is removable and/or replaceable. Optionally, the outer member 70 may be replaced in the field. As such, the amount of down time for the touch screen system 10 may be limited. Another feature of the touch screen cover 22 is that the inner bezel 34 and/or the printed wire board 36 are independent of the outer member 70. As such, the outer member 70 may be quickly replaced when desired, such as, for example, if the outer member is scratched, or if the outer member needs to be disinfected. Specifically, the inner bezel 34 and/or the printed wire board 36 may be removed from the outer member 70 prior to the outer member 70 being autoclaved or otherwise disinfected. Moreover, the inner bezel 34 and/or the printed wire board 36 may be quickly replaced when desired.

The above-described embodiments provide a cost effective and reliable means for using a touch screen system 10. Specifically, the touch screen system 10 includes a touch screen cover 22 having a unitarily formed display filter 26, rim 30, and outer bezel 32. Additionally, the touch screen cover 22 includes non-angular, radiused surfaces to transition between each of the display filter 26, the rim 30, and the outer bezel 32. Accordingly, the touch screen cover 22 is configured to be cleaned and or disinfected. Additionally, the touch screen cover 22 does not include any crevasses or seams between any of the display filter 26, the rim 30, and the outer bezel 32 to collect or retain bioburden or moisture therein. As a result, the touch screen cover 22 is useful in reducing the cleaning time and the overall operating costs of the touch screen system 10.

Exemplary embodiments of a touch screen cover 22 are described above in detail. The touch screen cover 22 is not limited to the specific embodiments described herein, but rather, components of each touch screen cover 22 may be utilized independently and separately from other components described herein. For example, each touch screen cover 22 component can also be used in combination with other touch screen cover 22 components.

While the invention has been described in terms of various specific embodiments, those skilled in the art will recognize that the invention can be practiced with modification within the spirit and scope of the claims.

What is claimed is:

1. A touch screen cover comprising a display filter having a front surface configured to be positioned to at least partially cover a display screen, said display filter having a rim integrally formed with and extending along at least a portion of a perimeter of said front surface of said display filter, said rim projecting outward from said front surface away from the display screen, and said rim being configured to pass infrared light therethrough along said front surface.

2. The touch screen cover of claim 1 further comprising a bezel integrally formed with said rim, said bezel surrounding said display filter and positioned forward of said front surface.

3. The touch screen cover of claim 1 further comprising a printed wire board interior to and surrounding said rim, said printed wire board having infrared elements configured to one of transfer and receive infrared traces through said rim and along said front surface.

4. The touch screen cover of claim 1 further comprising a bezel integrally formed with said rim and a printed wire board snappably mounted to said bezel, said printed wire board having at least one infrared element provided thereon.

5. The touch screen cover of claim 1 further comprising a bezel, said bezel, said rim and said display filter being monolithically formed.

6. The touch screen cover of claim 1 wherein said rim entirely surrounds the perimeter of said front surface of said display filter.

7. The touch screen cover of claim 1 wherein said rim is integrally formed with said front surface of said display filter at a transition area including a predetermined radius of curvature between said rim and said display filter.

8. The touch screen cover of claim 1 wherein said rim forms an infrared lens having inner and outer surfaces angled at a non-orthogonal angle to infrared traces projecting through said infrared lens.

9. The touch screen cover of claim 1 wherein said rim forms an infrared lens having inner and outer surfaces angled substantially perpendicular to infrared traces projecting through said infrared lens.

10. The touch screen cover of claim 1 further comprising an outer bezel integrally formed with said rim, and an inner bezel positioned adjacent said outer bezel.

11. The touch screen cover of claim 1 further comprising an outer bezel integrally formed with said rim, an inner bezel positioned adjacent said outer bezel, and a printed wire board snappably mounted to said inner bezel, such that said inner bezel is positioned between said printed wire board and said outer bezel.

12. A touch screen system comprising:
a display comprising a display screen configured to present application specific information;
a touch screen cover coupled to said display, said touch screen cover comprising a display filter having a front surface configured to be positioned to at least partially cover the display screen, said display filter having a rim integrally formed with and extending along at least a portion of a perimeter of said front surface of said display filter, said rim projecting outward from said front surface away from the display screen, and said rim being configured to pass infrared light therethrough along said front surface.

13. The touch screen system of claim 12 further comprising a bezel integrally formed with said rim, said bezel surrounding said display filter and positioned forward of said front surface.

14. The touch screen system of claim 12 further comprising a printed wire board surrounding said rim, said printed wire board having infrared elements configured to one of transfer and receive infrared traces along said front surface.

15. The touch screen system of claim 12 further comprising a bezel integrally formed with said rim and a printed wire board snappably mounted to said bezel, said printed wire board having at least one infrared element provided thereon.

16. The touch screen system of claim 12 further comprising a bezel, said bezel, said rim and said display filter being monolithically formed.

17. The touch screen system of claim 12 wherein said rim is integrally formed with said front surface of said display filter at a transition area including a predetermined radius of curvature between said rim and said display filter.

18. The touch screen system of claim 12 wherein said rim forms an infrared lens having inner and outer surfaces angled at one of (a) a non-orthogonal angle to infrared traces projecting through said infrared lens, and (b) a substantially perpendicular angle to infrared traces projecting through said infrared lens.

19. The touch screen system of claim 11 further comprising an outer bezel integrally formed with said rim, and an inner bezel positioned adjacent said outer bezel.

20. The touch screen system of claim 11 further comprising an outer bezel integrally formed with said rim, an inner bezel positioned adjacent said outer bezel, and a printed wire board snappably mounted to said inner bezel, such that said inner bezel is positioned between said printed wire board and said outer bezel.

21. The touch screen system of claim 11 wherein said touch screen cover is removably coupled to said display.
